(19) United States
(12) Patent Application Publication
(10) Pub. No.: US 2002/0056722 A1
(43) Pub. Date: May 16, 2002

(54) DEVICE FOR AUTOMATIC SPRAY APPLICATION OF PAINT

(76) Inventor: TERJE VELDE, STAVANGER (NO)

Correspondence Address: CONNOLLY BOVE LODGE & HUTZ, LLP, 1220 N MARKET STREET, P O BOX 2207, WILMINGTON, DE, 19899

(21) Appl. No.: 09/402,087

(22) PCT Filed: Mar. 30, 1998
(86) PCT No.: PCT/IB98/00461

(30) Foreign Application Priority Data
Apr. 3, 1997 (SE) 9701203-3
May 9, 1997 (SE) 9701745-3
Aug. 6, 1997 (SE) 9702862-5

(51) Int. Cl. B67D 5/08

(52) U.S. Cl. 222/69

(57) ABSTRACT

In a device for automatic spray application of paint through a spray nozzle a unit providing paint is arranged to be connected to the nozzle (2) during the application for providing this with paint, and this unit is formed by a paint container (5) adapted to be arranged close to the spray nozzle. The device has members adapted to receive and hold the container close to the spray nozzle detachably and removably from the device for exchange thereof against such containers when there is a desire of more paint in the container and/or paint change.

### FIELD OF THE INVENTION AND PRIOR ART

The present invention relates to a device for automatic spray application of paint through a spray nozzle, which comprises a unit providing paint and adapted to be connected to the nozzle during the application for providing the nozzle with paint.

Such a device may have different fields of uses, but for illuminating but not in any way restricting the invention the use of such a device for painting objects, such as vehicle bodies, by a spray application robot will hereinafter mainly be discussed, but the invention also comprises devices in the form of so called painting machines. “Paints” is here to be given a broad meaning and comprises all types of paints and varnishes suited for spray application.

Devices of this type already known have a number of units providing paint in the form of paint sources centrally located remotely with respect to the spray robot, one for each type of paint and colour, which are connected to the spray nozzle through a ring conduit each. Furthermore, a choice of paint takes place locally on the device in question, so that a large amount of valves, easily in the order of 60, have to be arranged on the spray robot. This means several important drawbacks, primarily in the case of an increasing amount of possible types of paints and colours to be sprayed by the spray robot. For a larger such amount a large number of hoses running to and back from the spray robot are required, which makes the device expensive and also restricts the possibility of the spray robot to move. Furthermore, it also means that a large number of hoses have to be kept clean and free from obstructions. Furthermore, a large number of valves and control means are as already mentioned required for controlling them. This means in its turn that quite a volume of paint gets lost when colour is changed, since it is very important that no old paint having another colour is mixed into the new paint to be sprayed by the spray robot.

Another drawback relates to water born paints, which are more and more frequently used, since these paints have a higher viscosity than paints on oil base, so that a higher pumping pressure is required for pumping the paint to the spray robot and the risk of depositing in and obstructing of hoses is increased. Furthermore, considerable problems to obtain an electric insulation between the paint sources and the spray nozzle arise in electrostatic painting while using water born paints and said ring conduits.

### SUMMARY OF THE INVENTION

The object of the present invention is to provide a device of the type defined in the introduction, which to a large extent finds a remedy to the inconveniences mentioned above of such devices already known.

This object is according to the invention obtained by providing a device, in which said unit providing paint is formed by a paint container designed to be arranged close to the spray nozzle, and the device has members adapted to receive and hold the container close to the spray nozzle detachably and removably from the device for exchange for another such container when there is a desire of more paint in the container and/or change of paint.

Thus, the invention is based on moving said unit providing paint all the way to the proximity of the spray nozzle, so that said connection to the spray nozzle gets very short during the application. Long ring conduits subjected to plugging and which require a comparatively high pump power, especially when pumping water born paints having a high viscosity, are by this avoided. The device will neither be loaded with a large number of hoses and valves for feeding paint of different colours to the nozzle, but colour change takes easily place by changing the container. A certain container may be intended for a certain colour and all the time be filled with paint of the same colour, so that then no cleaning of the container is required before refilling paint. Any insulating problems neither occur in using water born paints in connection with electrostatic painting, since the unit providing paint constituted by the container is separated from possibly main conduits for supply of paint and an incorporated “high voltage block” is obtained through the separate container.

According to a preferred embodiment of the invention the device comprises means adapted to dose paint fed from the container to the spray nozzle for spray application, and these dosing means are adapted to influence the inner volume of the container present for receiving paint for pressing paint out to the nozzle through an opening of the container through a reduction of said volume. By dosing paint fed from the container to the spray nozzle in this way a very exact and reliable dosing of the paint may take place through simple means.

According to another preferred embodiment of the invention said means are adapted to act upon the container from the outside for compressing said volume for paint dosing. The dosing means will through this not come into contact with the paint and no cleaning of the dosing means at colour change is required as for the devices already known, which saves time as well as paint and cleaner.

According to another preferred embodiment of the invention the container is made compressible, and said means are adapted to compress the container. By such a compressing a very exact dosing of paint to the spray nozzle may take place.

According to another preferred embodiment of the invention the container has a bellows-like construction for facilitating compression of the container. A very exact and uniform dosing of paint to the spray nozzle may by this be achieved.

According to another preferred embodiment of the invention the container has a wall being displaceable with respect to is the other walls of the container while maintaining a tight delimitation of said volume and the dosing means are adapted to act upon said displaceable wall for displacing thereof for dosing paint to the nozzle. Also this embodiment makes it possible to achieve an exact dosing of paint fed to the spray nozzle by simple means.

According to another preferred embodiment of the invention the dosing means comprise a power member having a piston and a piston rod and adapted to act upon the container through the piston for compressing said volume. This design for feeding paint in a dosed manner to the spray nozzle makes a very exact dosing possible.

According to another preferred embodiment of the invention the container is prolonged at the opening thereof by a feeding tube adapted to be held by said receiving members in a position in which it is inserted in the nozzle. By providing the container with such a feeding tube extending all the way into the spray nozzle, the need of cleaning of the paint paths of the device will be reduced and restricted at the most to the end of the spray nozzle located downstream of the feeding tube and the paint loss will be minimised when the change to a paint of another colour is carried out.

According to another preferred embodiment of the invention the device is arranged in a spray application robot having a nozzle located at the free end of one robot arm, and said receiving members comprise a space delimited inside said robot arm and adapted to receive said container. The container may by this be safely held in place and protected against external influences, at the same time as a very compact unit providing paint is obtained.

According to another preferred embodiment of the invention said dosing means are arranged inside the robot arm in a space adjacent to said space. This means that the dosing means may be protected against external damage and a unit providing paint having dosing means is obtained in a very compact way inside the robot arm.

According to a very preferred embodiment of the invention said robot arm is arranged openable for inserting and taking out the container into and out of said space, respectively, by the arrangement of one end piece of said arm pivoted with the respect to the rest of the arm about an axis substantially perpendicular to the longitudinal axis of the arm, said end piece has the space for receiving the container, and the space, for the dosing means is arranged in the part of the robot arm connecting to said end piece. This makes a very simple inserting and taking out of a container into and out of the space intended therefor inside the robot arm, respectively, possible without for that sake said dosing means being in the way in any way.

Further advantages as well as advantageous features of the invention will appear from the following description and the other dependent claims.

### BRIEF DESCRIPTION OF THE DRAWINGS

With reference to the appended drawings, below follows a description of preferred embodiments of the invention cited as examples.

In the drawings:

FIG. 1 is a very schematic view of a robot for spray application of paint onto a vehicle body, in which this robot is provided with a paint container close to the spray nozzle thereof,

FIG. 2 is a view partially sectioned and enlarged with respect to FIG. 1 of a device according to a first preferred embodiment of the invention,

FIG. 3 is a partially sectioned view of the device shown in FIG. 2 in a position in which it has no container but is ready for receiving a new container therein,

FIG. 4 is a view of a container according to a possible design of a device according to the invention,

FIG. 5 is a view illustrating a container corresponding to FIG. 4 according to another preferred design,

FIG. 6 is a view corresponding to FIG. 2 of a device according to another preferred embodiment of the invention, and

FIG. 7 is a view illustrating an additional possible design of a part of a device according to the invention.

### DETAILED DESCRIPTION OF PREFERRED EMBODIMENS OF THE INVENTION

A device for spray application of paint arranged in a spray application robot, which has different robot arms hingedly interconnected, is very schematically illustrated in FIG. 1. A spray nozzle 2 in the form of a gun, but it may also be the question of a bell, is arranged all the way out on the last robot arm 1 for spray application of atomised paint onto an object 3, here a vehicle body. The robot arm 1 is pivoted with respect to an adjacent robot arm 4 for directing the spray nozzle 2 towards the object in question.

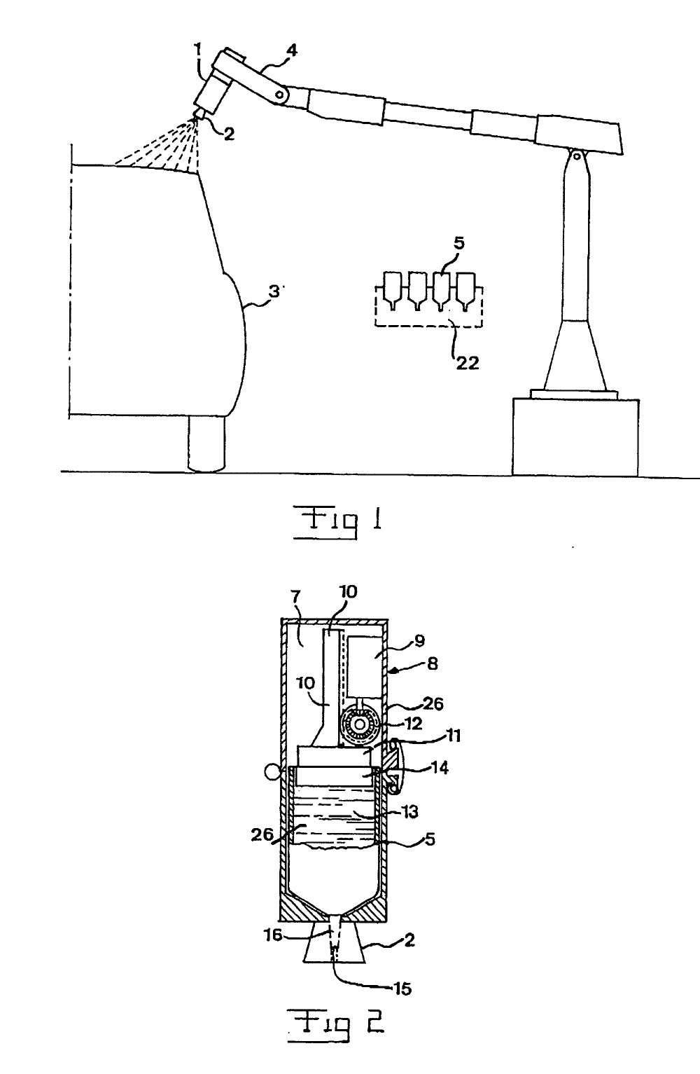

It is illustrated in FIG. 2 how the robot arm 1 is adapted to receive a paint container 5 in a first space 6 inside the robot arm 1. This container is held detachably and removably in place of the robot arm in a way to be explained further on. Means for dosing paint fed from the container to the spray nozzle 2 for spray application is arranged in a second space 7 adjacent to said first space 6. The dosing means comprise a power member 8, which has a motor 9, for example an electric motor, which is adapted to influence a piston rod 10 and by that a piston 11 to move in the direction towards and away from the nozzle 2. This movement is hear achieved by the fact that a gear wheel 12 driven by the motor 9 drives the piston rod 10 constructed as a gear rack.

The container 5 has an inner volume 13 for receiving paint, and this inner volume may be changed by the fact that the wall 14 of the container is displaceable with respect to the other walls of the container while maintaining the tight delimitation of the volume 14. The piston 11 is adapted to bear against the wall 14 of the container so as to determine the inner volume thereof and by reducing it press paint out of the nozzle 2, as well as assist in holding the container in place inside the robot arm 1.

The container 5 has a feeding tube 16 at its opening 15 to the nozzle 2, through which the container is prolonged and which is intended to be inserted in the nozzle 2 when the container is received in the robot arm 1. Furthermore the opening of the container has members schematically indicated at 17 and adapted to close said opening during transport and positioning of the container into the intended position in the robot arm 1 and then prevent paint from leaving the container. Conventional members not shown are arranged in the nozzle for atomising the paint.

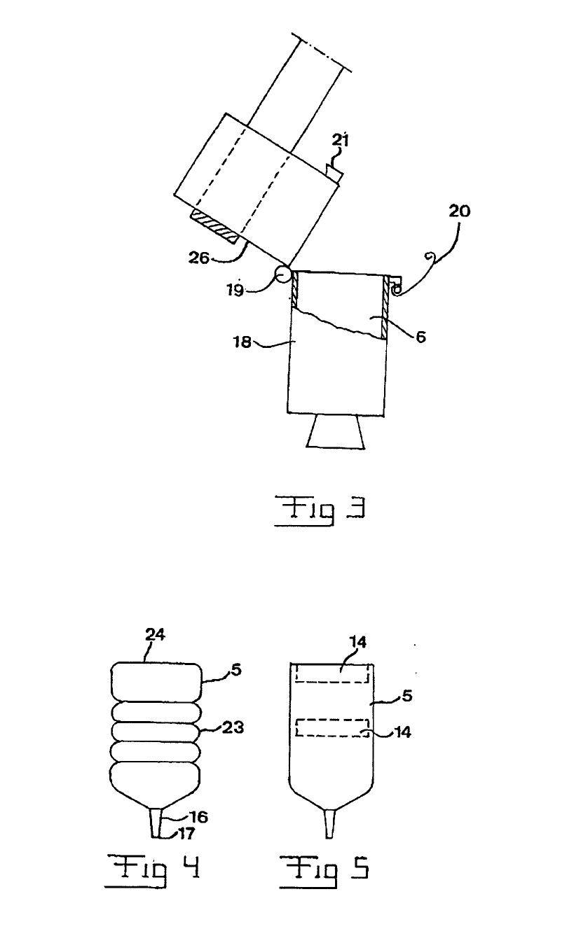

It is illustrated in FIG. 3 how the robot arm 1 may be opened for inserting and taking out the container into and out of the space 7, respectively, by the fact that an end piece 18 of the robot arm is pivoted with respect to the rest of the arm 26 about an axis 19 being substantially perpendicular to the longitudinal axis of the arm. Members 20, 21 are arranged on the end piece and the part of the robot arm located upstream, respectively, for locking these two parts to each other after inserting a container into the space 6. By adjusting the robot arm 1 in an appropriate way at container change, the gravitation may as illustrated in FIG. 3 be utilised for holding the end piece IS in such a position that the container change may easily take place. However, it would also be possible to arrange the axis 19 so that a lateral pivoting of the end piece 18 is carried out for opening and closing.

It is illustrated in FIG. 1 that it is meant that a supply 22 of containers 5 shall be present within reach of the robot, so that this may go there and change the container when colour change is desired or the paint in the container in question has run out. Means not shown for filling the containers 5 are preferably located at or in close connection to the supply 22.

Another preferred embodiment of a container usable in a device according to the invention is illustrated in FIG. 4, which is made of plastic and has portions having a bellows-like construction 23 for facilitating compression of the container. The piston 11 will then act upon the rear surface 24 of the container 5 for procuring compression thereof for feeding of paint in a dosed manner through the feeding tube 16 out of the nozzle 2.

The embodiment of the container 5 usable in a device according to the present invention and also shown in FIG. 2 is schematically shown in FIG. 5. It is illustrated by dashing that the wall 14 is moveable towards and away from the feeding tubes 17 for feeding of paint in a dosed manner through the spray nozzle 2.

Furthermore, the device has certain parts having nothing to do with the invention and have therefore not been shown in the figures, such as conduits for energy supply to the motor 9 and means for bringing the paint 25 contained in the container 5 to high voltage potential on electrostatic painting.

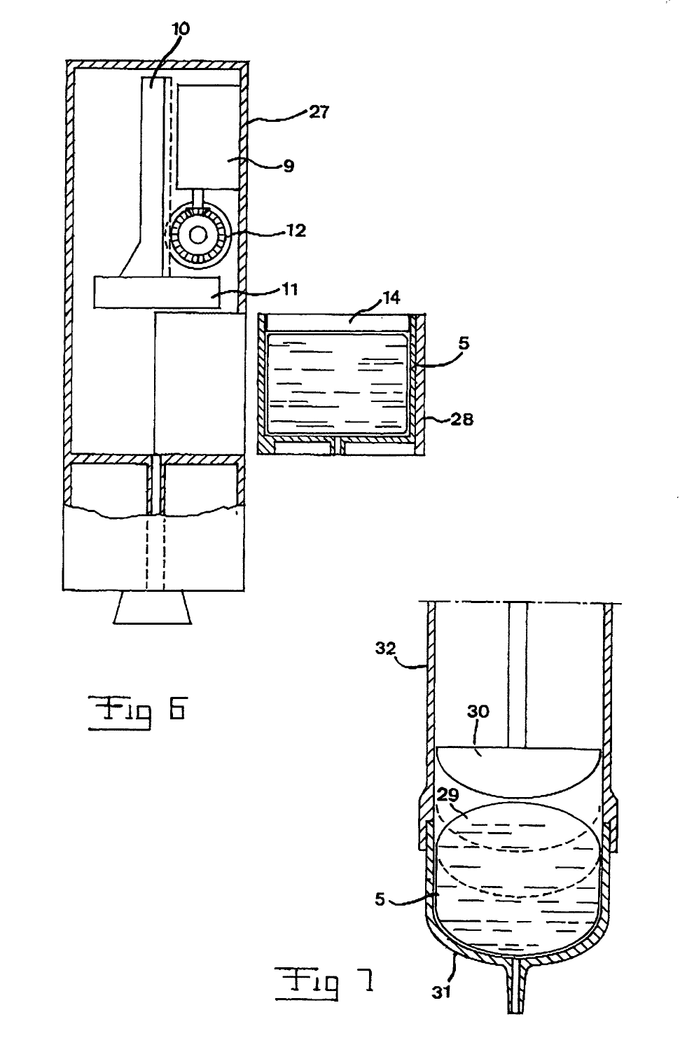

It is illustrated in FIG. 6 how according to another preferred embodiment of the invention the container 5 may be inserted and taken out into and out of the applicator body 27 of a spray robot, respectively, through a lateral translation movement. The container is also here provided with an end wall 14 displaceable with respect to the other walls of the container. The container 5 is received in a holder 28 forming a part of the applicator body. The container 5 may after taking the holder 28 out be taken out thereof and a new filled container may be introduced into the holder and this then be inserted into the applicator body 27 again.

Another alternative, in which the container 5 has a round flexible top portion 29, is illustrated in FIG. 7, in which said top portion may be compressed for dosing paint through a piston 30 driven by a motor and having a shape corresponding to the shape of the bottom of a solid body 31, in which the container 5 is arranged. Paint may by this through the piston 30 be pushed out through the container, and different possible positions of the piston is illustrated through the dashed lines. The solid body is removable from the body 32 containing the piston for change of container, in which the solid body 31 and the body may be connected to each other through for example a thread connection, a bayonet connection or any type of snap-in connection.

The invention is of course not in any way restricted to the preferred embodiments described above, but many possibilities to modifications thereof would be apparent to a man skilled in the art without departing from the basic idea of the invention.

Other power members may for example be arranged for compressing the container containing paint for feeding of paint in a dosed manner out through the nozzle 2.

The container could have a tooth paste tube-like appearance and the dosing means may comprise members, such as rolls, which from one end gradually compress the “tube” toward the opening of the container for a feeding of paint in a dosed manner therethrough.

1. A device for automatic spray application of paint through a spray nozzle (2), which comprises a unit providing paint and adapted to be connected to the nozzle during the application for providing the nozzle with paint, said unit providing paint being formed by a paint container (5) designed to be arranged close to the spray nozzle, said device having members (6, 18) adapted to receive and hold the container close to the spray nozzle detachably and removably from the device for exchange for another such container when there is a desire of more paint in the container and/or change of paint, and means (8-12) adapted to dose paint fed from the container (2) to the spray nozzle for spray application, said dosing means being adapted to influence the inner volume (13) of the container present for receiving paint for pressing paint out to the nozzle through an opening (15) of the container through a reduction of said volume, characterized in that said means (8-12) are adapted to act upon the container (5) from the outside for compressing said volume (13) for paint dosing.

2. A device according to claim 1, characterized in that the container (5) is made compressible, and that said means are adapted to compress the container.

3. A device according to claim 2, characterized in that at least portions of the container (5) has a bellows-like construction (23) for facilitating compressing or the container.

4. A device according to claim 1, characterized in that the container (5) has a wall (14) being displaceable with respect to the other walls of the container while maintaining a tight delimitation of said volume (13) and that the dosing means are adapted to act upon said displaceable wall for displacing thereof for dosing paint to the nozzle.

5. A device according to any of claims 1-4, characterized in that the dosing means comprise a power member (8) having a piston (11) and a piston rod (10) and adapted to act upon the container (5) by the piston for compressing said volume (13).

6. A device according to any of claims 1-5, characterized in that the container is at an opening thereof prolonged by a feeding tube (16) adapted to be held by said receiving members (6, 18) in a position in which it is inserted in the nozzle (2).

7. A device according to any of claims 1-6, characterized in that an opening (15) of the container (5) is provided with a member (17) adapted to close the opening thereof during transport and positioning in said receiving members so as to then prevent paint from leaving the container.

8. A device according to any of claims 1-7, characterized in that it is arranged in a spray application robot having a nozzle (2) located at the free end of one robot arm (1).

9. A device according to claim 8, characterized in that said receiving members comprise a space (6) delimited inside said robot arm and adapted to receive said container (5).

10. A device according to claim 8, characterized in that said dosing means (8-12) are arranged inside the robot arm (1) in a space (7) adjacent to said space (6).

11. A device according to claim 9 or 10, characterized in that said robot arm (1) is made openable for inserting and taking out a container (5) into and out of said space (18), respectively, by the arrangement of one end piece of said arm pivoted with the respect to the rest of the arm about an axis substantially perpendicular to the longitudinal axis of the arm.

12. A device according to claim 11, characterized in that said end piece (18) comprises the space (6) for receiving the container.

13. A device according to claims 10 and 11 or 12, characterized in that the space (7) for the dosing means is arranged in the part (26) of the robot arm connecting to said end piece (18).
